(19) United States
(12) Patent Application Publication
(10) Pub. No.: US 2021/0389705 A1
(43) Pub. Date: Dec. 16, 2021

(54) IMAGE FORMING APPARATUS

(71) Applicant: KYOCERA Document Solutions Inc., Osaka (JP)

(72) Inventors: Ryohei Tokunaga, Osaka (JP); Yoshiyuki Odaka, Osaka (JP)

(21) Appl. No.: 17/348,650

(22) Filed: Jun. 15, 2021

(30) Foreign Application Priority Data
Jun. 16, 2020 (JP) 2020-103533

(51) Int. Cl. G03G 15/20; G06K 15/14; G06K 15/16; G03G 15/00

(52) U.S. Cl. CPC G03G 15/2039; G06K 15/14; G03G 15/2064; G03G 15/50; G06K 15/16

(57) ABSTRACT

An image forming apparatus is provided with a sheet conveying device, a transfer device, a fixing device, a temperature sensor, a temperature control portion, and a conveyance control portion. The temperature control portion regulates power supplied to the heater by comparing between a temperature measured by the temperature sensor and a preset target temperature. The temperature control portion sets the target temperature to a first target temperature when an operation mode is a normal mode, and to a second target temperature lower than the first target temperature when the operation mode is a special mode. In a case in which the sequential printing process is performed, the conveyance control portion makes the sheet conveying device convey sheets at a longer interval when the operation mode is the special mode than when the operation mode is the normal mode.

### INCORPORATION BY REFERENCE

This application is based upon and claims the benefit of priority from the corresponding Japanese Patent Application No. 2020-103533 filed on Jun. 16, 2020 the entire contents of which are incorporated herein by reference.

### BACKGROUND

The present disclosure relates to an image forming apparatus provided with a fixing device that heats and presses a toner image on a sheet.

An electrophotographic image forming apparatus is provided with a fixing device that heats and presses a toner image transferred on a sheet. Such a fixing device is provided with: a heater; a heat transfer member to be heated by the heater; and a pressure member that forms a nip through which sheets pass between the pressure member and the heat transfer member on a conveyance path for the sheet.

The sheet may curl up when passing the fixing device. The sheet is more prone to curling when the sheet has a high water content and there is a significant difference in temperature between the heat transfer member and the pressure member.

As a solution to preventing curling of the sheet in the image forming apparatus, it is known that, in a case in which a sequential printing process is performed, a target temperature for heater control in the fixing device is set to be higher for a time interval between consecutive sheets than for a time period of passage of a sheet.

The time period of passage of a sheet means a time period for which the sheet is passing through the nip in the fixing device. The time interval between consecutive sheets means a time period from when the m-th sheet leaves the nip until when the (m+1)-th sheet reaches the nip.

### SUMMARY

An image forming apparatus according to one aspect of the present disclosure is provided with a sheet conveying device, a transfer device, a fixing device, a temperature sensor, a temperature control portion, and a conveyance control portion. The sheet conveying device conveys a sheet along a conveyance path. The transfer device transfers a toner image onto the sheet on the conveyance path. The fixing device is provided with: a heater; a heat transfer member to be heated by the heater; and a pressure member that forms a nip between the pressure member and the heat transfer member on the conveyance path. By heating and pressing the toner image on the sheet passing through the nip, the fixing device fixes the toner image onto the sheet. The temperature sensor measures a temperature of the heat transfer member. The temperature control portion regulates the power supplied to the heater by comparing between the temperature measured by the temperature sensor and a preset target temperature. The conveyance control portion controls the sheet conveying device. The temperature control portion sets the target temperature to a predetermined first target temperature when an operation mode is a normal mode, and to a second target temperature that is lower than the first target temperature when the operation mode is a special mode. In a case in which a sequential printing process in which images are sequentially formed on the sheets is performed, the conveyance control portion makes the sheet conveying device convey the sheets at a longer interval when the operation mode is the special mode than when the operation mode is the normal mode.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 illustrates a configuration of an image forming apparatus according to an embodiment.

FIG. 2 illustrates a configuration of a fixing device in the image forming apparatus according to the embodiment.

FIG. 3 is a block diagram illustrating a configuration of a control device in the image forming apparatus according to the embodiment.

FIG. 4 is a flowchart representing an example of a procedure for a fixing device start-up control by the image forming apparatus according to the embodiment.

### DETAILED DESCRIPTION

Hereinafter, one or more embodiments of the present disclosure will be described with reference to the drawings. Each embodiment to be described below is one example of the present disclosure and shall not be interpreted in any way to limit the technical scope of the present disclosure.

[Configuration of the Image Forming Apparatus 10]

An image forming apparatus 10 according to an embodiment is provided with a printing device 40 that performs a printing process, a process of forming an image on a sheet 9. The printing device 40 performs the printing process by electrophotography. The sheet 9 is an image formation medium such as a sheet of paper or a sheet-like resin member.

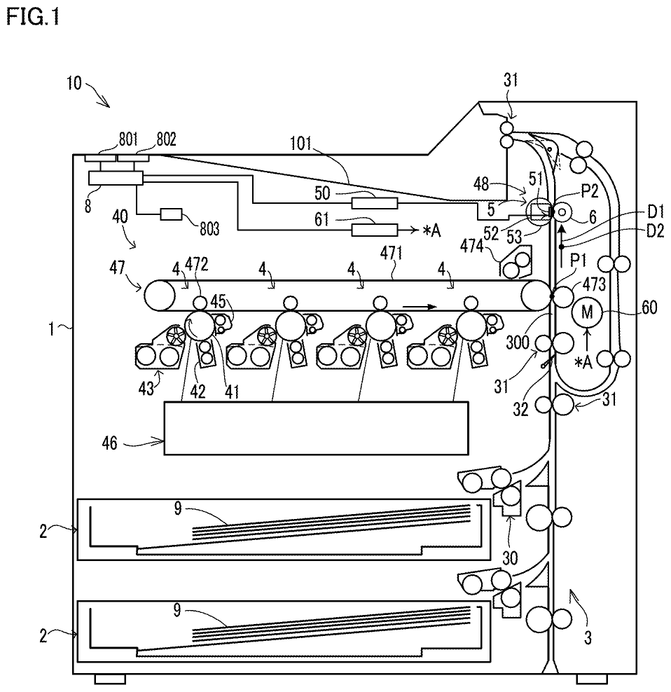

Referring to FIG. 1, the image forming apparatus 10 is provided with a sheet conveying device 3, a printing device 40, a control device 8, an operation device 801, and a display device 802; these devices are provided in a main body 1 of the image forming apparatus 10.

The operation device 801 is an interface that accepts user input, and includes operation buttons and a touch-screen panel, for example. The display device 802 is a device that displays information, and includes a flat-panel display device such as a liquid-crystal display unit.

The sheet conveying device 3 is provided with a sheet feed device 30 and multiple pairs of conveying rollers 31. The sheet feed device 30 sends the sheet 9, which is loaded in a sheet case 2, to a conveyance path 300 of the main body 1.

The multiple pairs of the conveying rollers 31 are rotationally driven by a motor (not shown). The conveying rollers 31 of each pair rotate and allow the sheet 9 to pass through between themselves, thereby convey the sheet S to a discharge tray 101 along the conveyance path 30.

Hereinafter, a direction in which the sheet 9 is conveyed along the conveyance path 300 will be referred to as a sheet conveyance direction D1. A direction along the conveyance path 300, intersecting the sheet conveyance direction D1 will be referred to as a traverse direction D2. In the present embodiment, the traverse direction D2 is a direction perpendicular to the sheet conveyance direction D1.

The multiple pairs of the conveying rollers 31 include a pair of paper stop rollers 31a. The pair of the paper stop rollers 31a is disposed upstream of the sheet conveyance direction D1 with respect to a transfer position P1 of the conveyance path 300. The sheet conveying device 3 is further provided with a sheet sensor 32 that detects the sheet 9 that is about to reach the pair of the paper stop rollers 31a.

The pair of the paper stop rollers 31a stops rotating when a leading edge part of the sheet 9 reaches the pair of the paper stop rollers 31a, and starts rotating again after a brief period. Thereby, the time at which the sheet 9 is fed to the transfer position P1 is regulated.

When a predetermined period has elapsed since the sheet 9 is detected by the sheet sensor 32, the leading edge part of the sheet 9 reaches the pair of the paper stop rollers 31a.

In a sequential printing process in which the printing device 40 forms images sequentially on the sheets 9, the pair of the paper stop rollers 31a feeds the sheets 9 to the transfer position P1 one by one at a preset specified conveyance interval IT1 (see FIG. 3).

The printing device 40 forms a toner image on the sheet 9 conveyed along the conveyance path 300 by the sheet conveying device 3. The printing device 40 is provided with an imaging device 4, a laser scanning unit 46, a transfer device 47, and a fixing device 48. The imaging device 40 includes a drum-shaped photoconductor 41, a charging device 42, a developing device 43, a drum cleaning device 45, and the like.

The image forming apparatus 10 shown in FIG. 1 is a tandem color image forming apparatus. The printing device 40 is thus provided with four the imaging devices 4 corresponding to four toner colors: yellow, cyan, magenta, and black.

In the imaging device 4, as the photoconductor 41 rotates, the charging device 42 electrically charges a surface of the photoconductor 41. Subsequently, the laser scanning unit 46 draws an electrostatic image on the surface of the photoconductor 41 by laser scanning.

The developing device 43 then forms a toner image from the electrostatic image by supplying toner to the surface of the photoconductor 41.

The transfer device 47 transfers the toner image onto the sheet 9 at the transfer position P1 of the conveyance path 300. The transfer device 47 is provided with: an intermediate transfer belt 471; four first transfer devices 472 corresponding to the four imaging devices 4; a second transfer device 473; and a belt cleaning device 474.

In the transfer device 47, the first transfer device 472 transfers the toner image, which is carried on the surface of the photoconductor 41, onto a surface of the intermediate transfer belt 471. The toner image is thereby formed in color on the surface of the intermediate transfer belt 471.

The second transfer device 473 transfers the toner image, which is carried on the intermediate transfer belt 471, onto the sheet 9 on the conveyance path 300. The photoconductor 41 and the intermediate transfer belt 471 each is an example of an image-carrying member that rotates carrying the toner image.

When the image forming apparatus 10 is a monochrome image forming apparatus, the second transfer device 473 transfers the toner image, which is carried on the photoconductor 41, onto the sheet 9 on the conveyance path 300.

The drum cleaning device 45 removes toner remaining on the surface of the photoconductor 41. The belt cleaning device 474 removes toner remaining on the intermediate transfer belt 471.

While the sheet 9 passes through the nip Np1, the fixing device 48 fixes the toner image onto the sheet 9 by applying heat and pressure. A fixing position P2 is disposed downstream of the sheet conveyance direction D1 with respect to the fixing position P1.

The fixing device 48 is provided with a heating device 5, a pressure roller 6, a motor 60, and a motor driving circuit 61. The heating device 5 is provided with a heater 51, a supporting member 52, a sliding member 53, and a heater feeder circuit 50.

The sliding member 53 is a flexible, tubular member. In other words, the sliding member 53 is an endless, belt-like flexible tube. The sliding member 53 is a tubular film member, for example. The pressure roller 6 is a roller having an outermost layer made of an elastic material such as rubber. The sliding member 53 is disposed at the fixing position P2 in the traverse direction D2.

The heater 51 is disposed in the traverse direction D2 in a state of being in contact with a part of an inner surface of the sliding member 53, which is along the fixing position P2. The heater 51 heats the sliding member 53. The sliding member 53 is an example of a heat transfer member to be heated by the heater 51.

The heater 51 is constituted by a plurality of heating elements arranged in the traverse direction D2, for example. Each heating element produces heat by being supplied with power.

The supporting member 52 is a member supporting the heater 51. Similar to the heater 51, the supporting member 52 is disposed in the traverse direction D2 inside the sliding member 53.

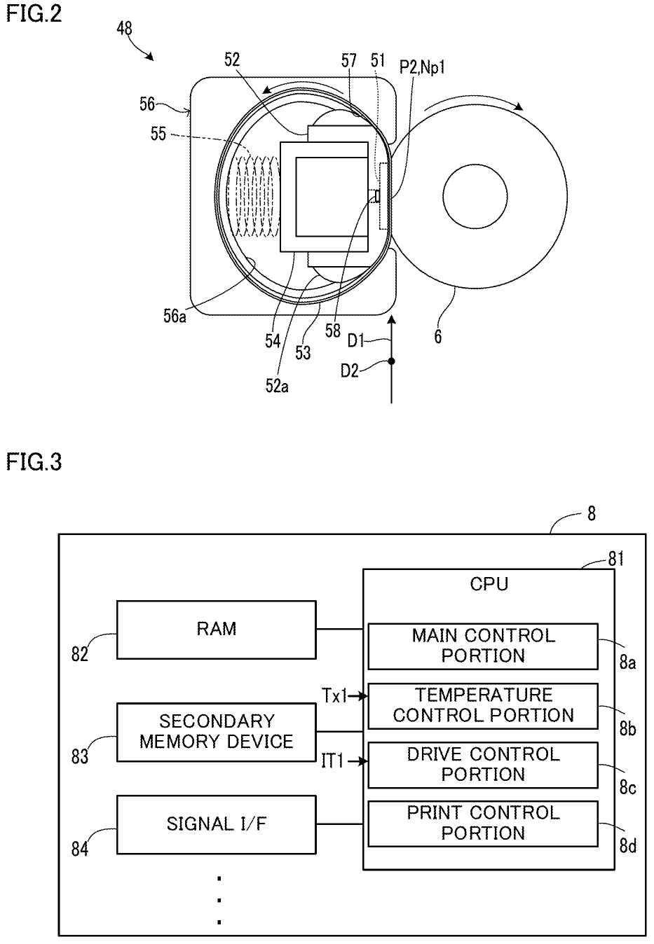

The sliding member 53 is supported such that it can rotate in a state of surrounding the heater 51 and the supporting member 52. Referring to FIG. 2, the fixing device 48 is further provided with a push member 54, a spring 55, and a pair of regulatory members 56.

The spring 55 elastically pushes the supporting member 52 via the push member 54 toward the fixing position P2. Being elastically pushed by the spring 55, the push member 54 pushes the supporting member 52. The push member 54 further serves to reinforce the supporting member 52.

The regulatory members 56 are disposed at both ends of the sliding member 53 in the traverse direction D2. The pair of the regulatory members 56 keeps the sliding member 53 from deviation in the traverse direction D2. Each regulatory member 56 has a rim guiding portion 56a that is internally protruded from the end part of the sliding member 53 in the traverse direction D2.

The rim guiding portions 56a of the regulatory members 56 guide the circumferential orbits of the both end parts of the sliding member 53 in the traverse direction D2, along a predetermined curved path.

By being rotated around the heater 51 and the supporting member 52, the sliding member 53 allows its inner surface to slide with respect to the heater 51 and the supporting member 52 in the sheet conveyance direction D1. The sliding member 53 allows its outer surface to be in pressure contact with the pressure roller 6 at the fixing position P2.

The supporting member 52 has multiple ribs 52a that serve to reduce a frictional resistance with the sliding member 53. The ribs 52a are spaced in the traverse direction D2. Each rib 52a extends in a rotational direction of the sliding member 53. The inner surface of the sliding member 53 is coated with a lubricant 57.

The pressure roller 6 is supported such that it can rotate in a state of being, at the fixing position P2, in pressure contact with a part of the sliding member 53 which is along the heater 51. The pressure roller 6 is an example of a pressure member.

The pressure roller 6 forms a nip Np1 through which the sheet S passes between the pressure roller 6 and a part of the sliding member 53 which is along the heater 51. The position at which the nip Np1 is formed is the fixing position P2.

The motor 60 rotationally drives the pressure roller 6. The motor driving circuit 61 supplies, to the motor 60, power determined by a speed command from the control device 8. This allows the motor 60 to rotate at a speed determined by the speed command. The motor driving circuit 61 is an inverter driving circuit, for example.

By the pressure roller 6 rotating, the sliding member 53 is rotated with respect to the pressure roller 6. In other words, the pressure roller 6 makes, by rotation, the sliding member 53 rotate following the rotation.

The heater feeder circuit 50 supplies, to the heater 51, power determined by a power command from the control device 8. When the power command indicates the extent of an increase or decrease of the amount of power supplied to the heater 51, for example, the heater feeder circuit 50 regulates the amount of the power supplied to the heater 51 in accordance with the power command.

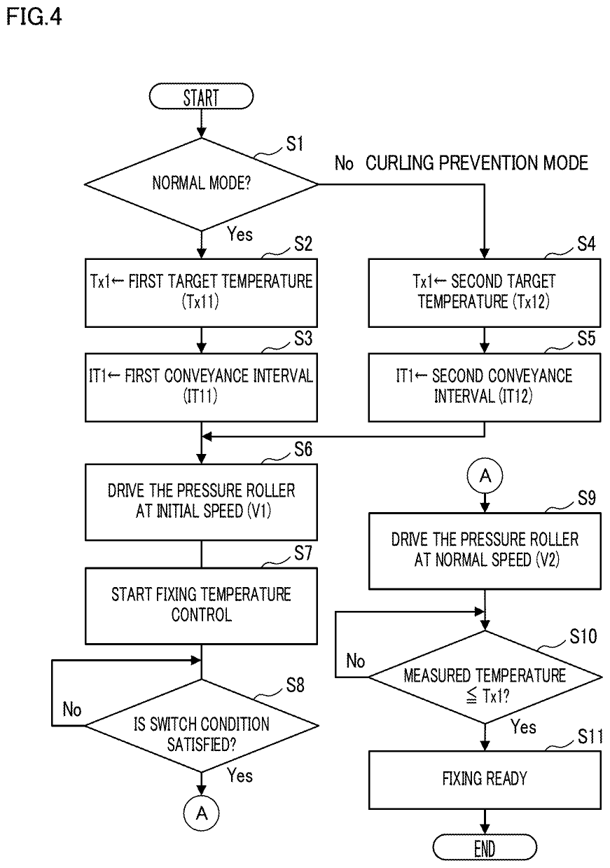

The heating device 5 is further provided with a temperature sensor 58 that measures a temperature of the heater 51. The temperature measured by the temperature sensor 58 is used for a fixing temperature control. The fixing temperature control is a feedback control in which the power supplied to the heater 51 is regulated by a comparison between the temperature of the heater 51 and a preset target temperature Tx1 (see FIGS. 3 and 4). The temperature sensor 58 is a thermistor, for example.

The temperature sensor 58 measures a temperature of the fixing position P2, i.e., an alternative indicator of a temperature of the nip Np1. So, the temperature sensor 58 may be disposed at a position at which a temperature of the sliding member 53 can be measured.

In the image forming apparatus 10, the sheet 9 may curl up when the sheet 9 passes the fixing device 48. The sheet 9 is more prone to curling when the sheet 9 has a high water content and there is a significant difference in temperature between the sliding member 53 and the pressure member 6.

[Control Device 8]

The control device 8 performs various data processes and controls devices such as the sheet conveying device 3, the printing device 40, and the display device 802.

Referring to FIG. 3, the control device 8 is essentially provided with a central processing unit (CPU) 81, a random access memory (RAM) 82, and peripheral devices such as a secondary memory device 83 and a signal interface 84.

The CPU 81 is a processor that performs various data processes and exercises control by executing computer programs. The RAM 82 is a transitory computer-readable memory device. The RAM 82 records the computer programs to be executed by the CPU 81 and temporarily records data to be outputted and referred to by the CPU 81 while the CPU 81 executes various processes.

The CPU 81 includes a plurality of process modules to be enabled by executing the computer programs. The processing modules include a main control portion 8a, a temperature control portion 8b, a drive control portion 8c, a print control portion 8d, and the like.

The main control portion 8a performs a start control for starting various processes as instructed via the operation device 801 and controls the display device 802.

The temperature control portion 8b regulates the amount of power supplied to the heating device 5 by the fixing temperature control. The temperature control portion 8b regulates the amount of the power supplied to the heating device 5 by controlling the heater feeder circuit 50.

The drive control portion 8c controls the sheet conveying device 3. The drive control portion 8c is an example of a conveyance control portion. The print control portion 8d makes the printing device 40 perform the printing process in sync with the conveyance of the sheet 9 by the sheet conveying device 3.

The secondary memory device 83 is a non-transitory computer-readable memory device. The secondary memory device 83 is capable of recording and updating the computer programs and data in various forms. Either or both of a flash memory and a hard disk drive, for example, are employed as the secondary memory device 83.

The signal interface 84 converts signals outputted by various sensors such as the temperature sensor 58 into digital data form, then transfers the digital data to the CPU 81. The signal interface 84 further converts control commands outputted by the CPU 81 into control signals, then transfers the control signals to controlled devices.

Preventing curling of the sheets 9 may take precedence over the productivity for making prints in the sequential printing process. A reduction of the power consumed by the image forming apparatus 10 is a matter of importance as well. It is not desirable that the target temperature Tx1 for heater control in the fixing device 48 be set to a high temperature because it will increase the power consumed by the heater 51.

In the present embodiment, the temperature control portion 8b and the drive control portion 8c perform the fixing device start-up control to be described later. In the fixing device start-up control, the target temperature Tx1 and the specified conveyance interval IT1 are set.

After start-up of the fixing device 48, the temperature control portion 8b regulates the power supplied to the heater 51 by the fixing temperature control based on the target temperature Tx1, and the drive control portion 8c regulates the conveyance interval of the sheets 9 in accordance with the specified conveyance interval IT1 in the sequential printing process. This allows preventing curling of the sheets 9 passing the fixing device 48, without increasing the power consumed by the fixing device 48.

Hereinafter, the temperature measured by the temperature sensor 58 will be referred to as the measured temperature. The target temperature Tx1 is a preset temperature to be compared to the measured temperature after start-up of the fixing device 48.

[Fixing Device Start-Up Control]

Hereinafter, an example of a procedure for the fixing device start-up control will be described with reference to a flowchart of FIG. 4.

The main control portion 8a starts the fixing device start-up control upon occurrence of a start-up event of the fixing device 48. The start-up event occurs when a job of the printing process is accepted by the print control portion 8d.

The signs S1, S2, . . . indicated in the following represent a plurality of steps in the fixing device start-up control. Step S1 will be executed first in the fixing device start-up control. The heater 51 and the motor 61 are inactive before the fixing device start-up control is started.

<Step S1>

In Step S1, the main control portion 8a judges whether the operation mode of the image forming apparatus 10 is a normal mode or a curling prevention mode.

Prior to starting the fixing device start-up control, the main control portion 8a sets the operation mode in accordance with a predetermined mode selection operation to the operation device 801.

The normal mode is a mode in which the productivity for making prints in the sequential printing process takes precedence over prevention of curling of the sheets 9. In contrast, the curling prevention mode is a mode in which prevention of curling of the sheets 9 takes precedence over the productivity for making prints in the sequential printing process.

The main control portion 8c makes the process proceed to step S2 upon judging that the operation mode is the normal mode, and to step S4 upon judging that the operation mode is the curling prevention mode. The curling prevention mode is an example of a special mode.

<Step S2>

In step S2, the temperature control portion 8b sets the target temperature Tx1 to a predetermined first target temperature Tx11. After that, the temperature control portion 8b makes the process proceed to step S2.

<Step S3>

In step S3, the drive control portion 8c sets the specified conveyance interval IT1 to a predetermined first conveyance interval IT11. After that, the drive control portion 8c makes the process proceed to step S6.

<Step S4>

In step S4, the temperature control portion 8b sets the target temperature Tx1 to a predetermined second target temperature Tx12 that is lower than the first target temperature Tx11. After that, the temperature control portion 8b makes the process proceed to step S5.

<Step S5>

In step S5, the drive control portion 8c sets the specified conveyance interval IT1 to a predetermined second conveyance interval IT12 that is shorter than the first conveyance interval IT11. After that, the drive control portion 8c makes the process proceed to step S6.

<Step S6>

In step S6, the drive control portion 8c rotates the motor 60 at a predetermined initial speed V1 by controlling the motor driving circuit 61. In other words, the motor 60 and the motor driving circuit 61 rotates the pressure roller 6 at the initial speed V1 in accordance with control commands from the drive control portion 8c. After that, the drive control portion 8c makes the process proceed to step S7.

<Step S7>

In step S7, the temperature control portion 8b starts the fixing temperature control and makes the process proceed to step S8. The amount of the power supplied to the heater 51 will be thereby regulated such that the measured temperature is equal to the target temperature Tx1 which is set in step S2 or S4.

<Step S8>

In step S8, the drive control portion 8c judges whether or not a predetermined switch condition is satisfied. The drive control portion 8c makes the process proceed to step S9 upon judging that the switch condition is satisfied, and repeats the process in step S8 upon judging that it is not satisfied.

The switch condition may include either or both of a temperature change condition and an elapsed time condition, for example. In the present embodiment, the switch condition is a logical product of the temperature change condition and the elapsed time condition.

The temperature change condition is a condition that the measured temperature has reached a predetermined reference temperature that is lower than the target temperature Tx1. The elapsed time condition is a condition that a period for which the pressure roller 6 continues rotating at the initial speed V1 has reached a predetermined first reference period. The elapsed time condition referred to herein means the same as a condition that the number of revolutions of the pressure roller 6 rotating at the initial speed V1 has reached a predetermined number.

The temperature change condition is an example of a condition for confirming that the lubricant 57 now has a sufficiently low viscosity. The elapsed time condition is an example of a condition for confirming that the lubricant 57 distributed all over the inner surface of the sliding member 53 has been heated to a sufficient degree by the heater 51.

<Step S9>

In step S9, the drive control portion 8c rotates the motor 60 at a normal speed V2 that is higher than the initial speed V1, by controlling the motor driving circuit 61. In other words, the motor 60 and the motor driving circuit 61 rotates the pressure roller 6 at the normal speed V2 in accordance with control commands from the drive control portion 8c. After that, the drive control portion 8c makes the process proceed to step S10.

<Step S10>

In step S10, the temperature control portion 8b keeps monitoring the measured temperature until the measured temperature reaches the target temperature Tx1. When the measured temperature reaches the target temperature Tx1, the temperature control portion 8b makes the process proceed to step S11.

<Step S11>

In step S11, the temperature control portion 8b causes a fixing ready event to occur and terminates the fixing device start-up control. The fixing ready event indicates that a temperature of the fixing device 48 has been raised enough and is ready to fix the toner image onto the sheet 9. The occurrence of the fixing ready event means allowing conveyance of the sheet 9 to start.

After termination of the fixing device start-up control, the temperature control portion 8b continues the fixing temperature control until a stop event of the fixing device 48 occurs.

Upon occurrence of the stop event, the temperature control portion 8b makes the heater feeder circuit 50 stop the power supplied to the heater 51.

When the operation mode is the normal mode, the target temperature Tx1 in the fixing temperature control is the first target temperature Tx11 (refer to step S2). In contrast, when the operation mode is the curling prevention mode, the target temperature Tx1 in the fixing temperature control is the second target temperature Tx12 (refer to step S4).

As indicated above, when the operation mode is the normal mode, the temperature control portion 8b sets the target temperature Tx1 to the predetermined first target temperature Tx11 (refer to step S2).

When the operation mode is the curling prevention mode, the temperature control portion 8b sets the target temperature Tx1 to the second target temperature Tx12 which is lower than the first target temperature Tx11 (refer to step S4).

In a case in which the sequential printing process is performed after termination of the fixing device start-up control, the drive control portion 8c makes the sheet conveying device 3 convey the sheets 9 at the specified conveyance interval IT1.

When the operation mode is the normal mode, the specified conveyance interval IT1 is the first conveyance interval IT11 (refer to step S3). In contrast, when the operation mode is the curling prevention mode, the specified conveyance interval IT1 is the second conveyance interval IT12 (refer to step S5).

In other words, in a case in which the sequential printing process is performed, the drive control portion 8c makes the sheet conveying device 3 convey the sheets 9 at a longer interval when the operation mode is the curling prevention mode than when the operation mode is the normal mode.

When the sequential printing process is performed, setting the target temperature Tx1 to a low temperature and setting the specified conveyance interval IT1 to a long interval will prevent a significant difference in temperature between the sliding member 53 and the pressure roller 6. This will result in preventing curling of the sheets 9.

So, when the operation mode is set to the curling prevention mode, curling of the sheets 9 passing the fixing device 48 will be prevented without increasing the power consumed by the fixing device 48.

Steps S1 to S11 of the fixing device start-up control correspond to a temperature-rise process in which the temperature measured by the temperature sensor 58 is raised to the target temperature Tx1 by operation of the heater 51.

In the temperature-rise process, the motor 60 and the motor driving circuit 61 rotate the pressure roller 6 at the preset initial speed V1 and subsequently at the normal speed V2 which is higher than the initial speed V1 (steps S6 to S9).

This will reduce a load to the motor 60 and a frictional load to the sliding member 53 when the lubricant 57 is low in temperature, namely, when the lubricant 57 is high in viscosity. This will result in reduction of the power consumed by the motor 60 and a slow degradation of the sliding member 53.

In the present embodiment, the motor 60 and the motor driving circuit 61, which rotate the pressure roller 6 in steps S1 to S3, are an example of a roller driving device.

[First Applied Example]

Hereinafter, a first applied example of the fixing device 48 will be described.

The image forming apparatus 10 is provided with a humidity sensor 803 that measures a humidity of an environment in which the image forming apparatus 10 is installed (see FIG. 1).

In step S5 of FIG. 4, the drive control portion 8c in the present applied example sets the specified conveyance interval IT1 to the second conveyance interval IT12 that is different depending on the humidity measured by the humidity sensor 803.

Specifically, in step S5 of FIG. 4, the drive control portion 8c sets the specified conveyance interval IT1 to the second conveyance interval IT12, wherein the second conveyance interval IT12 is longer when the humidity measured by the humidity sensor 803 does not fall within a predetermined reference humidity range than when the humidity measured by the humidity sensor 803 falls within the reference humidity range.

In other words, in a case in which the sequential printing process is performed in a condition in which the operation mode is the curling prevention mode, the drive control portion 8c in the present applied example makes the sheet conveying device 3 convey the sheets 9 at a longer interval when the humidity measured by the humidity sensor 803 does not fall within the reference humidity range than when the humidity measured by the humidity sensor 803 falls within the reference humidity range.

In general, the sheet 9 has a higher water content under high humidity than under low humidity. The sheet 9 absorbs a greater amount of heat from the pressure roller 6 when the sheet 9 has a high water content than when the sheet 9 has a low water content. So, when the sheet 9 passes through the nip Np1, the difference in temperature between the sliding member 53 and the pressure roller 6 is larger under high humidity than under low humidity.

In the present applied example, in a case in which the sequential printing process is performed in the curling prevention mode, the pressure roller 6 is heated by the heater 51 for a longer time under high humidity than under low humidity, during a time period in which the sheet 9 is not in the nip Np1.

So, the present applied example will prevent a significant difference in temperature between the sliding member 53 and the pressure roller 6 even when the sheets 9 have a high water content. This will result in preventing curling of the sheets 9.

[Second Applied Example]

Hereinafter, a second applied example of the fixing device 48 will be described.

The drive control portion 8c in the present applied example performs the same processes as the drive control portion 8c in the first applied example.

In step S4 of FIG. 4, the temperature control portion 8b in the present applied example sets the target temperature Tx1 to the second target temperature Tx12 that is different depending on the humidity measured by the humidity sensor 803.

Specifically, in step S4 of FIG. 4, the temperature control portion 8b sets the target temperature Tx1 to the second target temperature Tx12, wherein the second target temperature Tx12 is higher when the humidity measured by the humidity sensor 803 does not fall within the predetermined reference humidity range than when the humidity measured by the humidity sensor 803 falls within the reference humidity range.

In other words, in a case in which the sequential printing process is performed in a condition in which the operation mode is the curling prevention mode, the temperature control portion 8b in the present applied example sets the target temperature Tx1 to the second target temperature Tx12, wherein the second target temperature Tx 12 is higher when the humidity measured by the humidity sensor 803 does not fall within the reference humidity range than when the humidity measured by the humidity sensor 803 falls within the reference humidity range.

In the present applied example, in a case in which the sequential printing process is performed in the curling prevention mode, the pressure roller 6 is heated by the heater 51 for a longer time under high humidity than under low humidity, during a time period in which the sheet 9 is not in the nip Np1.

Furthermore, in the present applied example, in a case in which the sequential printing process is performed in the curling prevention mode, the pressure roller 6 absorbs more heat from the heater 51 under high humidity than under low humidity, by way of the sliding member 53 during a time period in which the sheet 9 is not in the nip Np1.

So, the present applied example will prevent a significant difference in temperature between the sliding member 53 and the pressure roller 6 even when the sheets 9 have a high water content. This will result in preventing curling of the sheets 9.

[Third Applied Example]

Hereinafter, a third applied example of the fixing device 48 will be described.

In the present applied example, the heater 51 further heats a part of the sliding member 53, other than the part of the sliding member 53 in which the nip Np1 is formed. The heater 51 referred to herein may be an IH heater or the like.

Furthermore, in the present applied example, the inner surface of the sliding member 53 slides with respect to a part of the supporting member 52 that faces the fixing position P2.

When the present applied example is employed, the same effectiveness as when the fixing device 48 is employed will be brought.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. An image forming apparatus comprising:
a sheet conveying device configured to convey a sheet along a conveyance path;
a transfer device configured to transfer a toner image onto the sheet on the conveyance path;
a fixing device comprising: a heater; a heat transfer member to be heated by the heater; and
a pressure member configured to form a nip between the pressure member and the heat transfer member on the conveyance path, the fixing device configured to fix the toner image onto the sheet by heating and pressing the toner image on the sheet passing through the nip;
a temperature sensor configured to measure a temperature of the heat transfer member or the heater;
a temperature control portion configured to regulate power supplied to the heater by comparing between the temperature measured by the temperature sensor and a preset target temperature; and
a conveyance control portion configured to control the sheet conveying device, wherein
the temperature control portion sets the target temperature to a predetermined first target temperature when an operation mode is a normal mode, and to a second target temperature when the operation mode is a special mode, the second target temperature being lower than the first target temperature, and
in a case in which a sequential printing process in which images are sequentially formed on the sheets is performed, the conveyance control portion makes the sheet conveying device convey the sheets at a longer interval when the operation mode is the special mode than when the operation mode is the normal mode.

2. The image forming apparatus according to claim 1, further comprising:
a humidity sensor configured to measure a humidity of an environment in which the image forming apparatus is installed, wherein
in a case in which the sequential printing process is performed in a condition in which the operation mode is the special mode, the conveyance control portion makes the sheet conveying device convey the sheets at a longer interval when the humidity measured by the humidity sensor does not fall within a predetermined reference humidity range than when the humidity measured by the humidity sensor falls within the reference humidity range.

3. The image forming apparatus according to claim 2, wherein
in a case in which the operation mode is the special mode, the temperature control portion sets the target temperature to the second target temperature, wherein the second target temperature is higher when the measured humidity does not fall within the reference humidity range than when the measured humidity falls within the reference humidity range.

4. The image forming apparatus according to claim 1, further comprising:
a supporting member configured to support the heater and disposed in a traverse direction intersecting a conveyance direction for the sheet, wherein
the heat transfer member is a flexible, tubular member surrounding the heater and the supporting member, and the heat transfer member allows an outer surface of the heat transfer member to be in pressure contact with the pressing component and allows a lubricant-coated inner surface of the heat transfer member to slide, by rotation, in the conveyance direction with respect to surfaces of the heater and the supporting member.
